(19) United States
(12) Patent Application Publication
(10) Pub. No.: US 2014/0183016 A1
(43) Pub. Date: Jul. 3, 2014

(54) LIGHTING MODULE

(71) Applicant: Ya-Chun Tu, Taipei City (TW)

(72) Inventor: Ya-Chun Tu, Taipei City (TW)

(73) Assignee: ASUSTEK COMPUTER INC., Taipei City (TW)

(21) Appl. No.: 13/944,901

(22) Filed: Jul. 18, 2013

(30) Foreign Application Priority Data
Dec. 27, 2012 (CN) 201210581386.0

(51) Int. Cl. H01H 13/02

(52) U.S. Cl. CPC H01H 13/023
USPC 200/314

(57) ABSTRACT

A lighting module is adapted to an electronic device. The electronic device includes a light transmitting portion. The lighting module comprises a light source and a microstructure. The light source is disposed in the electronic device, and the light source includes a light emitting surface facing the light transmitting portion. The microstructure is disposed between the light emitting surface of the light source and the light transmitting portion.

### CROSS-REFERENCE TO RELATED APPLICATION

This application claims the priority benefit of China application serial No. 201210581386.0, filed on Dec. 27, 2012. The entirety of the above-mentioned patent application is hereby incorporated by reference herein and made a part of specification.

### BACKGROUND OF THE INVENTION

1. Field of the Invention

The invention relates to a lighting module and, more particularly, to a lighting module which can enhance the uniformity of the light.

2. Description of the Related Art

With the development of the lighting technologies, lighting modules have been gradually applied to many electronic products and lighting lamps, such as keyboards, notebook computers, mobile phones and monitors. If the lighting module is disposed in the keyboard, the illuminant keyboard can be used in a dark environment, and users can recognize the symbols on the keys in the weak light, and a decorative effect is also better.

Conventionally, lighting modules are only set on one side or both sides of the light-emitting keyboard and the keys on the keyboard have different brightness due to different distances between keys and the light modules. A light source also may be set under each key of the light-emitting keyboard, so that the brightness of the keys of light-emitting keyboard is more uniform. However, since the keys on the keyboard have different sizes and the position of the light sources under the keycap also may be different, the intensity of the light emitted through each key may be different, which affects the visual effect.

### BRIEF SUMMARY OF THE INVENTION

A lighting module is provided, and it can enhance the uniformity of the light.

A lighting module adapted to an electronic device is disclosed. The electronic device includes a light transmitting portion. The lighting module comprises a light source and a microstructure. The light source is disposed in the electronic device, and the light source includes a light emitting surface facing the light transmitting portion. The microstructure is disposed between the light emitting surface of the light source and the light transmitting portion.

In summary, in order to make the light from the light emitting surface of the light source pass the microstructure first and then pass through the light transmitting portion, the microstructure is disposed between the light emitting surface of the light source and the light transmitting portion (for example, the microstructure is formed on the light emitting surface of the light source or at the bottom of the light transmitting portion). Consequently, the light is scattered by the microstructure and the uniformity of the light is enhanced. The lighting module can be applied to the keys of the light-emitting keyboard to make the keys with different sizes have similar brightness. In addition, the lighting module can also be used in indicators of common electronic devices.

The features and advantages of the present invention will become better understood with regard to the following description, appended claims, and accompanying drawings.

### BRIEF DESCRIPTION OF THE DRAWINGS

FIG. 1 is a schematic diagram showing a lighting module applied to an electronic device in an embodiment;

FIG. 2A to FIG. 2G are schematic diagrams showing the process for manufacturing microstructures of the lighting module in an embodiment;

FIG. 3A to FIG. 3D are schematic diagrams showing the process for manufacturing microstructures of the lighting module in another embodiment; and

FIG. 4 is a schematic diagram showing a lighting module applied to an electronic device in another embodiment.

### DETAILED DESCRIPTION OF THE EMBODIMENTS

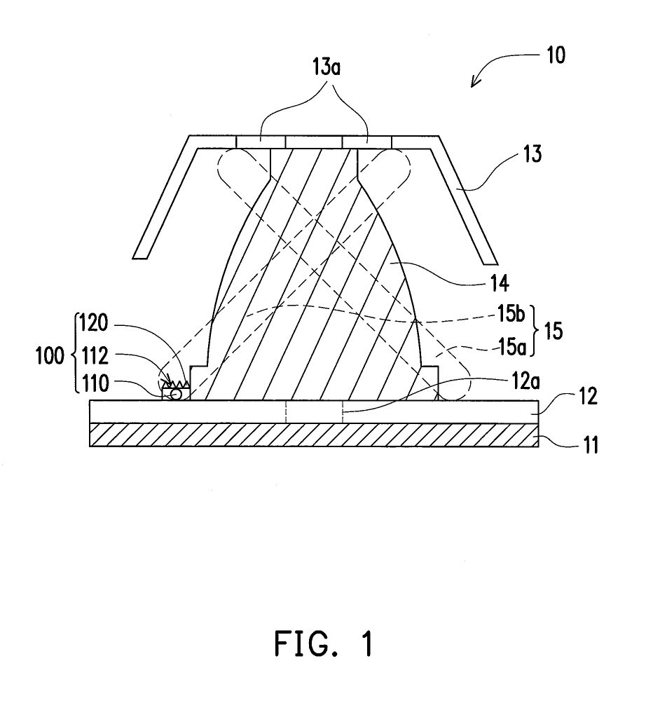

FIG. 1 is a schematic diagram showing a lighting module applied to an electronic device in an embodiment. Please refer to FIG. 1. The lighting module 100 is applied to an electronic device 10. The electronic device 10 is a light-emitting keyboard. The lighting module 100 is disposed under every key of the light-emitting keyboard, and the electronic device 10 is not limited to a light-emitting keyboard. In FIG. 1, only one key is shown.

As shown in FIG. 1, the electronic device 10 includes a baseplate 11, a circuit board 12, a keycap 13, an elastomer 14 and a support structure 15. The circuit board 12 is disposed on the baseplate 11, and the circuit board 12 includes a press part 12a.

The keycap 13 is disposed on the circuit board 12. The keycap 13 includes a light transmitting portion 13a. The character presented on the light transmitting portion 13a is corresponding to the character represented by the keycap 13, such as a numeral, a letter or a function.

The elastomer 14 is disposed between the circuit board 12 and the keycap 13. In detail, the elastomer 14 is disposed at the bottom of the keycap 13 corresponding to the press part 12a. When the keycap 13 is pressed, the elastomer 14 deforms and presses the press part 12a of the circuit board 12 to trigger the key.

The support structure 15 is connected to the keycap 13 and the baseplate 11 to make the keycap 13 movably fixed to the baseplate 11. The support structure 15 includes a first support 15a and a second support 15b which are crossed and pivotally connected. When the keycap 13 moves relatively to the baseplate, the first support 15a and the second support 15b make the keycap 13 move up and down smoothly.

The lighting module 100 includes a light source 110 and a microstructure 120. The light source 110 is a Light Emitting Diode, which is not limited herein. The light source 110 is electrically connected to the circuit board 12, and is disposed between the circuit board 12 and the keycap 13. The light source 110 includes a light emitting surface 112 facing the light transmitting portion 13a. The microstructure 120 is disposed between the light emitting surface 112 of the light source 110 and the light transmitting portion 13a. The microstructure 120 is disposed on the light emitting surface 112 of the light source 110, which is not limited herein.

Since the microstructure 120 is made of a light-transparent material, the light from the light emitting surface 112 of the light source 110 passes the microstructure 120 first and then passes through the light transmitting portion 13a. Thus, the light is scattered by the microstructure 120 and the uniformity of the light is enhanced when the light passes through the light transmitting portion 13a, and it provides a better visual effect.

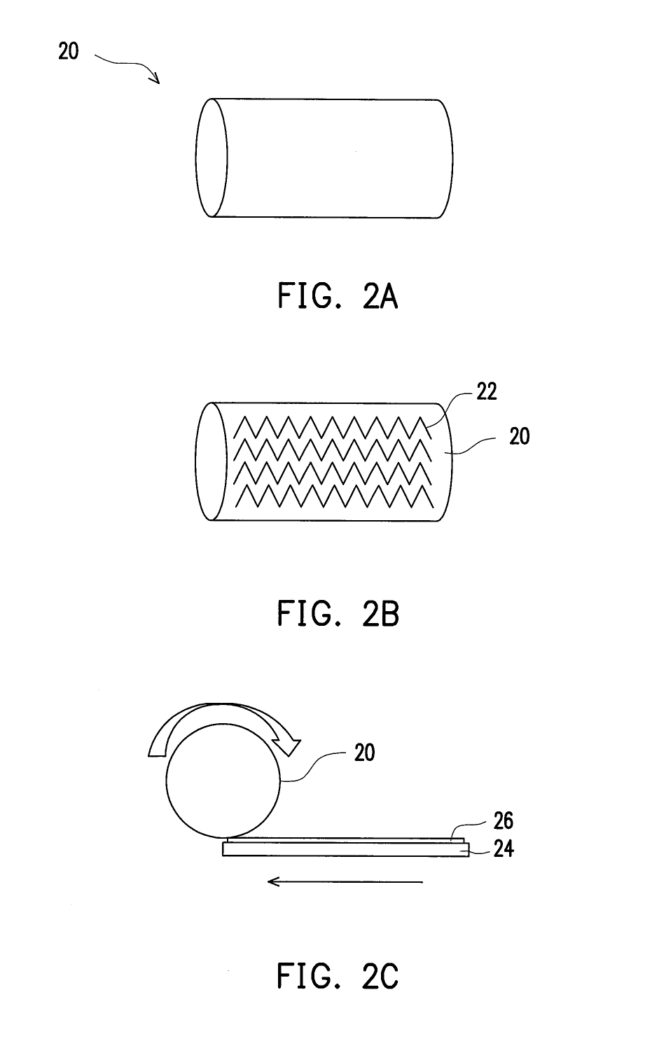

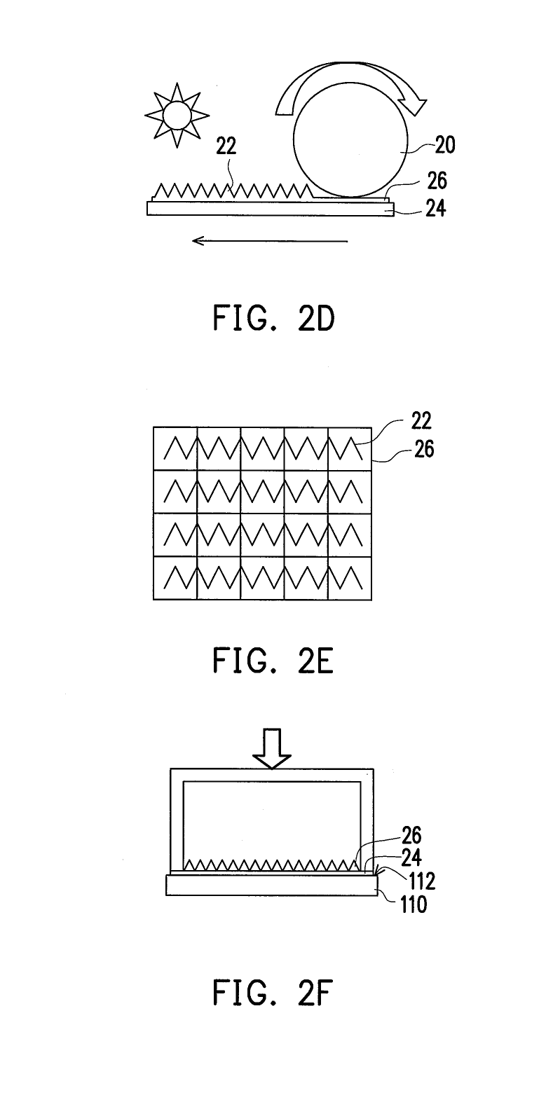

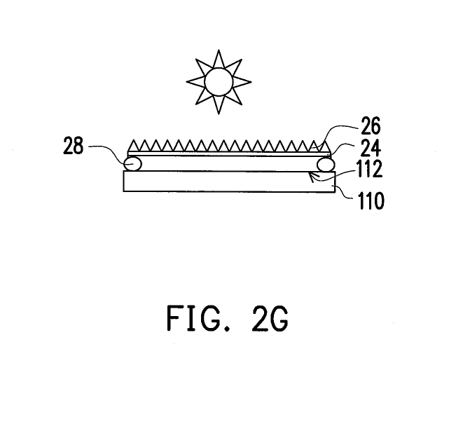

The microstructure 120 may be disposed on the light emitting surface 112 of the light source 110 by bonding or hot-press. FIG. 2A to FIG. 2G are schematic diagrams showing the process for manufacturing microstructures of the lighting module in an embodiment.

Please refer to FIG. 2A and FIG. 2B, firstly, a scroll wheel 20 is provided, and a microstructure pattern 22 is processed on the scroll wheel 20. Then, a film 24 is provided, and a glue layer 26 is coated on the film 24. The glue layer 26 is made of an ultraviolet glue, which is not limited herein. As shown in FIG. 2C, the scroll wheel 20 is rolled on the glue layer 26 to transfer the microstructure pattern 22 on the scroll wheel 20 to the glue layer 26.

As shown in FIG. 2D, the glue layer 26 is irradiated by ultraviolet light to solidify the microstructure pattern 22 on the glue layer 26. Then, the glue layer 26 together with the film 24 is cut into a desired size (as shown in FIG. 2E). Finally, the film 24 is fixed to the light emitting surface 112 of the light source 110 by the hot-press to form the microstructure 120 (as shown in FIG. 2F), or by bonding the film 24 to the light emitting surface 112 of the light source 110 via the glue layer 26 (as shown in FIG. 2G) to form the microstructure 120, Thus, the light from the light emitting surface 112 of the light source 110 passes the microstructure 120 first and then passes through the light transmitting portion 13a, and the uniformity of the light is enhanced.

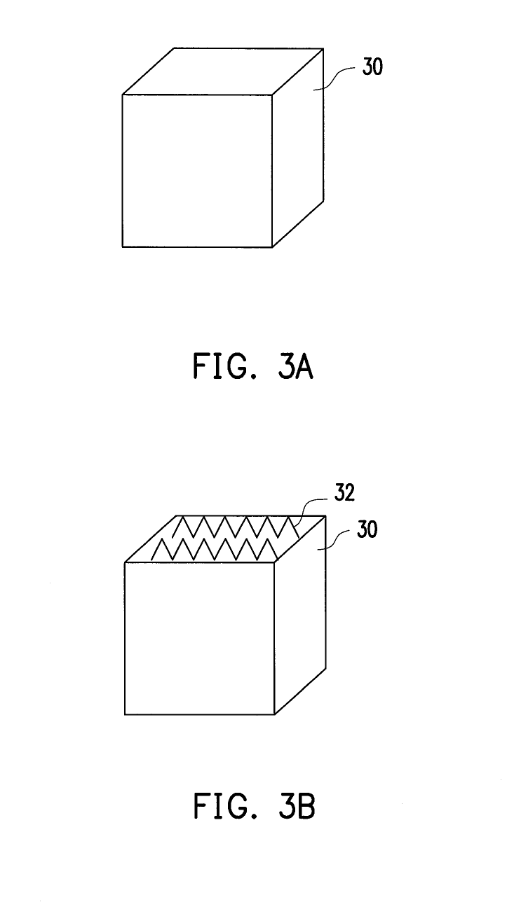

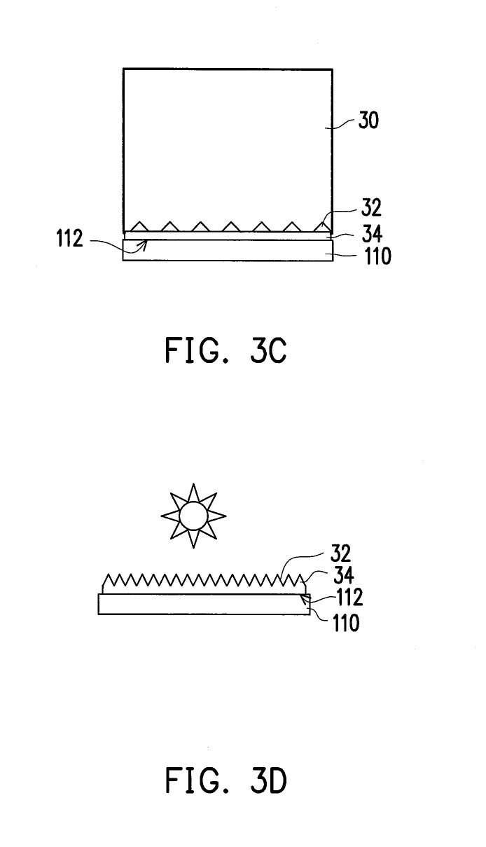

FIG. 3A to FIG. 3D are schematic diagrams showing the process for manufacturing microstructures of the lighting module in another embodiment. Please refer to FIG. 3A and FIG. 3B, firstly, a mold 30 is provided, and a microstructure pattern 32 is processed on the mold 30. Then, a glue layer 34 is coated on the light emitting surface 112 of the light source 110, and the microstructure pattern 32 on the mold 30 is imprinted on the glue layer 34. The glue layer 34 is made of an ultraviolet glue, which is not limited herein.

At last, the glue layer 34 on the light emitting surface 112 of the light source 110 is irradiated by the ultraviolet light to make the microstructure pattern 32 on the glue layer 34 solidified. In the embodiments, the microstructure 120 is formed and fixed to the light emitting surface 112 of the light source 110, however, the way for forming the microstructure 120 and the position of the microstructure 120 are not limited herein.

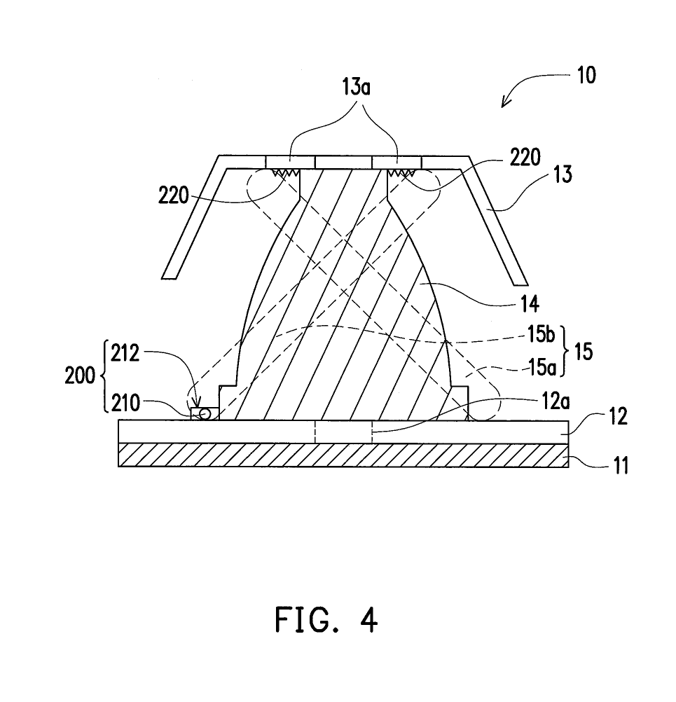

FIG. 4 is a schematic diagram showing a lighting module applied to an electronic device in another embodiment. Please refer to FIG. 4, the main difference between the lighting module 200 in FIG. 4 and the lighting module 100 in FIG. 1 is that the microstructure 220 in FIG. 4 is at the bottom of the light transmitting portion 13a while the microstructure 120 in FIG. 1 is on the light emitting surface 112 of the light source 110. The position of the microstructure 220 is not limited herein as long as the light from the light emitting surface 212 of the light source 210 passes the microstructure 220 first, and the light is scattered by the microstructure 220 and then passes through the light transmitting portion 13a to enhance the uniformity of the light.

In addition, the lighting module is not limited to be applied to a key of a light-emitting keyboard it may also be applied to indicators of an electronic device, such as the power indicator on the host computer or on the display. The lighting module provides better light uniformity via the configuration of the microstructure.

In summary, in order to make the light from the light emitting surface of the light source pass the microstructure first and then pass through the light transmitting portion, the microstructure is disposed between the light emitting surface of the light source and the light transmitting portion (for example, the microstructure is formed on the light emitting surface of the light source or at the bottom of the light transmitting portion). Consequently, the light is scattered by the microstructure, and the uniformity of the light is enhanced. The lighting module can be applied to the keys of the light-emitting keyboard to make the keys with different sizes have similar brightness. In addition, the lighting module can also be used in indicators of common electronic devices.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A lighting module adapted to an electronic device, wherein the electronic device includes a light transmitting portion, the lighting module comprising:
a light source disposed in the electronic device, wherein the light source includes a light emitting surface facing the light transmitting portion; and
a microstructure disposed between the light emitting surface of the light source and the light transmitting portion.

2. The lighting module according to claim 1, wherein the microstructure is disposed on the light emitting surface of the light source.

3. The lighting module according to claim 1, wherein the microstructure is disposed at a bottom of the light transmitting portion.

4. The lighting module according to claim 1, wherein the electronic device further includes:
a baseplate;
a circuit board disposed on the baseplate;
a keycap disposed on the circuit board, wherein the keycap includes the light transmitting portion, and
an elastomer, disposed between the circuit board and the keycap.

5. The lighting module according to claim 4, wherein the light source is electrically connected to the circuit board and disposed between the circuit board and the keycap.

6. The lighting module according to claim 4, wherein the electronic device further includes a support structure connected to the keycap and the baseplate to movably fix the keycap to the baseplate.

7. The lighting module according to claim 4, wherein the support structure includes a first support and a second support which are crossed and pivotally connected.

8. The lighting module according to claim 4, wherein the circuit board includes a press part, the elastomer is disposed at a bottom of the keycap corresponding to the press part.

9. The lighting module according to claim 1, wherein the microstructure is made of a light-transparent material.

10. The lighting module according to claim 1, wherein the light source is a Light Emitting Diode (LED).
